(19) United States
(12) Patent Application Publication
(10) Pub. No.: US 2023/0070107 A1
(43) Pub. Date: Mar. 9, 2023

(54) ARCHIVAL PRINTED ARTICLES AND METHODS

(71) Applicant: Joshua Daniel NADEAU, Keene, NH (US)

(72) Inventor: Joshua Daniel NADEAU, Keene, NH (US)

(21) Appl. No.: 17/889,704

(22) Filed: Aug. 17, 2022

Related U.S. Application Data
(60) Provisional application No. 63/234,010, filed on Aug. 17, 2021.

(51) Int. Cl. B41M 5/50; B41M 7/00; B32B 7/12; B32B 29/00; B32B 37/12

(52) U.S. Cl. CPC B41M 5/502; B41M 7/0027; B32B 7/12; B32B 29/005; B32B 37/12; B32B 2250/26; B32B 2255/12; B32B 2255/28; B32B 2307/7246

(57) ABSTRACT

Articles and methods for archival raised image printing is disclosed. The process includes modifying an electronic image, printing the image on a paper substrate to form a printed substrate, applying the printed substrate onto a barrier substrate via an applicator such that the applicator creates a wall around the outer edge of the image, coating the printed substrate with a varnish composition, and drying the printed substrate in a humidity controlled environment. This configuration provides an efficient system of archival printing to print raised images on an article.

### CROSS-REFERENCE TO RELATED APPLICATION

The present application claims priority to and the benefit of U.S. Provisional Patent Application No. 63/234,010, filed Aug. 17, 2021, the contents of which are hereby incorporated in their entirety.

### FIELD OF THE INVENTION

The invention relates generally to archival printed articles and methods of making the same.

### BACKGROUND OF THE INVENTION

Archival pigment printing is a printmaking process that incorporates refined particles of pigment resilient to elements that commonly degrade and erode dye molecules which shorten a print's life. Archival prints may replicate any traditional image and can be reproduced in a wide range of sizes. Current printing techniques, however, may be costly, and inefficient, especially if the desired result is to print a raised image on an article.

### SUMMARY OF THE INVENTION

There is a need to provide an efficient system of archival printing to print raised images on an article. The invention relates, in some aspects, to methods and products that facilitate raised image archival printing.

An embodiment of the present disclosure includes a method for printing an image. The method includes modifying an electronic image on a computing device to form a modified electronic image. The method further includes printing, with a printing machine, the modified electronic image on a paper substrate to form a printed substrate with an image thereon, wherein the paper substrate comprising a cellulosic material. The method further includes applying the printed substrate onto a barrier substrate. The method further includes applying a template to the printed substrate and the barrier substrate to form a wall around an outer perimeter of the image. The method further includes coating the image with a curable varnish composition. The method further includes drying the printed substrate in a humidity controlled environment to cure the varnish composition, thereby causing the image to extend upwardly from the base substrate a predetermined distance.

A further embodiment of the present disclosure includes an article including a base substrate. The base substrate includes an upper surface, a lower surface opposite the upper surface, and a length and a width that is greater than a thickness of the base substrate. The article further includes a barrier substrate having a first side coupled to the base substrate and a second side opposite the first side. The article further includes a coating comprising a varnish composition coupled to the upper surface of the base substrate. The article further includes a raised image extending from the upper surface of the base substrate.

Each of the limitations of the invention can encompass various embodiments of the invention. It is therefore anticipated that each of the limitations of the invention involving any one element or combinations of elements can be included in each aspect of the invention. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

### BRIEF DESCRIPTION OF THE DRAWINGS

The figures are illustrative only and are not required for enablement of the invention disclosed herein.

FIG. 1A is a diagram illustrating a printed article according to an embodiment of the present disclosure;

FIG. 1B is a partial cross-sectional view of the printed article shown in FIG. 1A;

FIG. 1C is a partial cross-sectional view of a printed article according to another embodiment of the present disclosure;

FIG. 2 is a process flow diagram illustrating process steps in the manufacture of a printed article;

FIG. 3 is a partial cross-sectional view of the printed article shown in FIG. 1A held by a template; and

FIG. 4 is a schematic diagram illustrating a system according to an embodiment of the present disclosure.

### DETAILED DESCRIPTION OF THE INVENTION

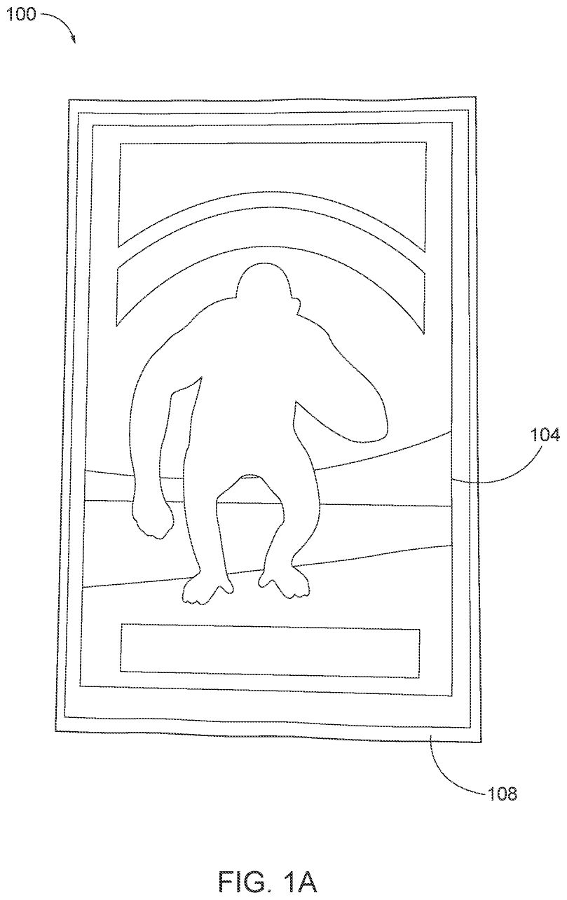

Aspects of the invention relate to systems and methods for printing raised images on an article. As shown in FIG. 1, the article 100 includes a base substrate 104, a barrier substrate 108 coupled to the base substrate 104, a coating 112 coupled to the base substrate 104 opposite the barrier substrate 108, and at least one raised image 116 extending from the base substrate 104.

The base substrate 104 acts as a material that supports the image media. The base substrate 104 includes an upper surface 120 and a lower surface 124 opposite the upper surface 120. In the illustrated embodiment, the base substrate 104 includes a length L1 and a width W1 that is greater than a thickness T1 of the base substrate 104. In one embodiment, the length L1 is between about 30 inches and about 32 inches, the width W1 is between about 40 inches and 44 inches, and the thickness T1 is about 1 inch. In another embodiment, the dimensions of the base substrate 104 vary. In the illustrated embodiment, the base substrate 104 may be an archival paper medium.

The barrier substrate 108 includes a first side 128 coupled to the base substrate 104 and a second side 132 opposite the first side 128. In one embodiment, the barrier substrate 108 is a rigid piece of material in which the image being raised is attached directly.

The coating 112 covers the upper surface 120 of the base substrate 104. The coating 112 comprises a curable varnish composition coupled to the upper surface 120 of the base substrate 104. In the illustrated embodiment, the varnish composition comprises a mixture of matte, satin, and gloss varnish. In another embodiment, the varnish composition comprises a ratio of 2 parts satin varnish to 1 part matte varnish. In another embodiment, the varnish composition comprises a ratio of 2 parts matte varnish to 1 part satin varnish.

The article 100 includes at least one raised image 116. The at least one raised image 116 is a modified electronic image printed onto the base substrate 104. In one embodiment, the article 100 include a single raised image 116 (depicted in FIG. 1B). In other embodiments, the article 100 includes two or more raised images (depicted in FIG. 1C). The raised image 116 extends from the upper surface 120 of the base substrate 104. The dimensions of the raised image 116 vary. In the illustrated embodiments, the raised image 116 has a thickness of at least 1.0 mm. In addition, in the illustrated embodiment, the raised image 116 occupies a portion of the upper surface 124 such that an inner edge of the raised image 116 and an outer perimeter of the upper surface 124 form an offset. In another embodiment, the raised image 116 may occupy the entirety of the upper surface 124 such that an inner edge of the raised image 116 and an outer perimeter of the upper surface 124 do not form an offset. The raised image 116 does not create a reverse indentation on the lower surface 124. In one embodiment, the raised image 116 is a squared imaged. In another embodiment, the raised image 116 may be raised text or images of various shapes.

The raised image 116 comprises a set of pigments and a curable composition. In the illustrated embodiment, the set of pigments include archival pigment inks. In one example, the archival pigment inks are Canon LUCIA PRO inks. In another example, other archival pigment inks are utilized. In the illustrated embodiment, the curable composition is a liquid varnish. In one example, the liquid varnish includes the following composition and specifications:

| Component | Active Concentration by Weight | Viscosity |
|---|---|---|
| Gloss | 36.75% | 150 |
| Satin | 42% | 150 |
| Mate | 35% | 150 |

In another example, the liquid varnish includes the following composition and specifications:

| Component | Active Concentration by Weight | Viscosity |
|---|---|---|
| Gloss Base | 35% | 150 |
| Mate Base | 35% | 150 |

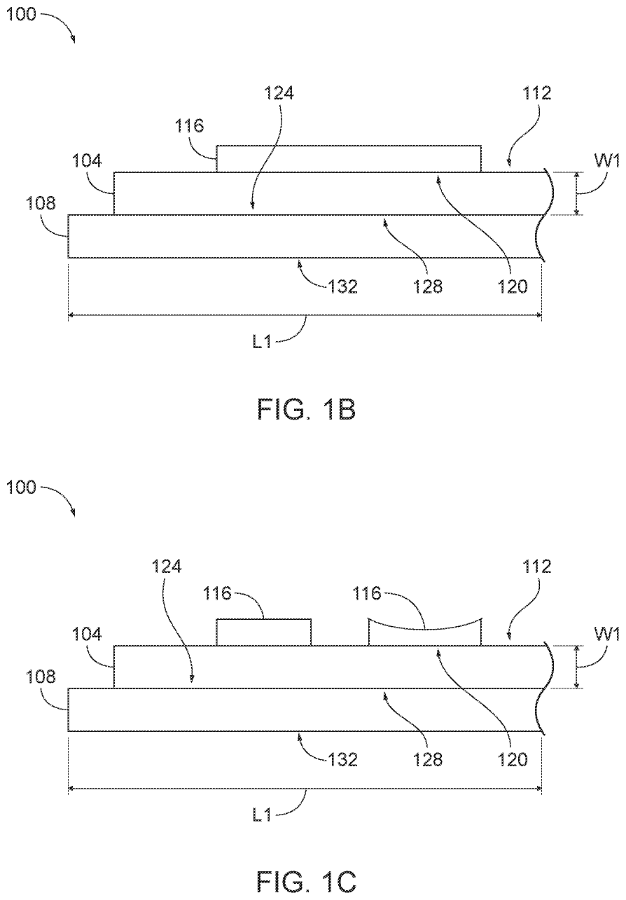

A method of making a printed article according to an embodiment of the disclosure is illustrated in FIG. 2. In step 204, an electronic image is obtained and modified to form a modified electronic image. The electronic image may be a Library of Congress digital file or any scanned image of artwork. The electronic image may be modified on a computing device by adjusting the colors and the shaping of the electronic image in order to ensure that the printed image is consistent with the electronic image that is viewable on a screen.

In step 208, the modified electronic image is printed onto a paper substrate via a printing machine to form a printed substrate with an image thereon. In the illustrated embodiment, the paper substrate is an archival paper medium. In the illustrated embodiment, the paper substrate further includes a cellulosic material. In one embodiment, the paper substrate comprises 100% cotton. In another embodiment, the paper substrate is Red River paper. In another embodiment, the paper substrate is Hahnemuhle paper. In alternative embodiments, the paper substrate may vary.

The electronic image is printed onto the paper substrate using pigment inks. In this configuration, the electronic image is printed onto the paper such that there is no difference in texture between the printed portions and unprinted portions of the paper substrate. In the illustrated embodiment, the electronic image is printed onto the paper substrate using archival pigment inks. In one example, Canon LUCIA PRO inks may be utilized to print the electronic image onto the paper substrate. In other examples, various archival pigment inks are utilized to print the electronic image onto the paper substrate.

In step 212, the printed substrate is applied onto a barrier substrate barrier substrate using a frame to create a printed construct. In the illustrated embodiment, the barrier substrate may be a kraft paper. The printed substrate is applied onto the barrier substrate via an applicator. The applicator is configured to couple the printed substrate and the barrier substrate and create a wall around the outer perimeter of the printed image. In one embodiment, the applicator is one or more adhesives. In one example, artist tape is applied to the paper substrate such that areas of the paper substrate without the printed image are taped off. In another embodiment, painters tape may be subsequently applied over the applied artist tape.

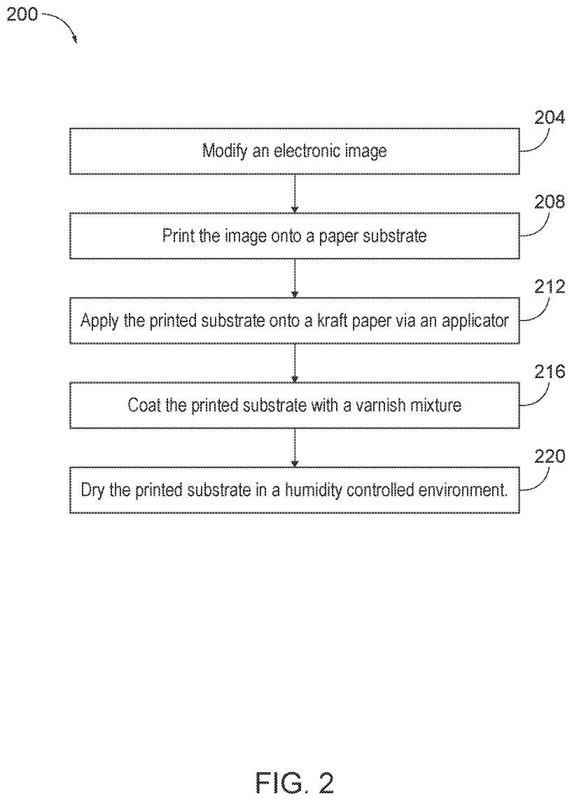

Referring to FIG. 3, in another embodiment, the applicator is a template. The template is a frame structure configured to maintain a level of tension along a length and a width of the printed substrate. The template forms a wall around an outer perimeter of the printed image. For example, the template may be two L-shaped brackets combined to form the shape of a “T-square”. The template is scalable having a length and width adjustment to fit around printed images of different sizes. The template may include a back side having a flat surface and a beveled edge that is non-perpendicular to the paper substrate.

In the illustrated embodiment, the template is comprised of aluminum. The thickness of the template is set to a desired height. The template creates a 90 degree vertical perimeter between the printed image and the template. The vertical perimeter forms a uniform, vertically-raised image.

The barrier substrate is configured to act as a moisture barrier that prevents moisture from penetrating through the paper substrate. The barrier substrate includes a front side exposed to the printed substrate, and a back side opposite the front side. The printed substrate is thus applied to a portion of the front side of the barrier substrate such that a border of excess barrier substrate is maintained once the printed substrate is applied onto the barrier substrate. In the illustrated embodiment, the barrier substrate is mylar or archival kraft paper. The excess barrier substrate may be trimmed, resulting in solely the printed substrate being backed on the barrier substrate.

The printed substrate backed on the barrier substrate may be placed on a temporary poster backing. In the illustrated embodiment, the temporary poster backing may be construction floor padding. The printed substrate backed on the barrier substrate with temporary backing may then be transported to an environmentally controlled room. The printed substrate may be tacked to a flat vertical surface. In one embodiment, the vertical flat surface may be a template base positioned on a lower side of the barrier substrate. For example, the template base may be a stiff cardboard positioned on the lower side of the barrier substrate. The vertical flat surface may be tacked to the printed substrate via staples. In alternative embodiments, various known materials and tacking means may be utilized for the vertical flat surface. In one embodiment, a vacuum table may be utilized to hold the template and printed substrate in place. The intersection of the printed substrate backed on the barrier substrate with temporary backing and the vertical flat surface may be sealed via one or more adhesives.

Continuing with FIG. 2, in step 216, the printed substrate is coated with a curable varnish composition using a coating machine. In the illustrated embodiment, the printed substrate is coated with a museum grade varnish composition. In one embodiment, the varnish composition comprises a mixture of matte, satin, and gloss varnish. In another embodiment, the varnish composition comprises a ratio of 2 parts satin varnish to 1 part matte varnish. In another embodiment, the varnish composition comprises a ratio of 2 parts matte varnish to 1 part satin varnish. In alternative embodiments, the type of varnish and amount of mixture may vary. In one embodiment, prior to varnishing, the printed substrate may be embossed over the image. Depth and circumference of the varnish may be preset to accurately set the height of said image, and also utilize less varnishing material.

In the illustrated embodiment, a first coat of varnish composition is sprayed onto the printed substrate. The varnish composition may be sprayed using a compressed air HVLP system with a fine detail gun. The first coat is then moved around the printed substrate to cover the printed substrate. The first coat is then dried for approximately 15 minutes inside an environmentally controlled room. This process is repeated two additional times, resulting in three coats of varnish composition on the printed substrate. In alternative embodiments, the process may be repeated more than two times for additional coats of varnish composition on the printed substrate. The applicator or template is subsequently removed from the printed substrate. In the illustrated embodiment, the painters tape is first removed and the printed substrate is air dried in a controlled environment for approximately 15 minutes and the artists tape is subsequently removed.

In step 220, the varnish composition is then cured and dried via a drying machine in a separate environmentally controlled room for approximately 60-90 minutes. The printed substrate is dried in a humidity-controlled environment. In the illustrated embodiment, the environment may include an internal temperature between 60 degrees and 65 degrees. The environment may further include a low humidity. For example, the environment may include a humidity that is less than about 75%. After the printed substrate is dried, the dried and coated printed substrate may subsequently be transported to an original vintage printing press. Pressure may be applied on the dried and coated printed substrate for a predetermined period of time. This configuration results in the image being raised off of the surface of the substrate.

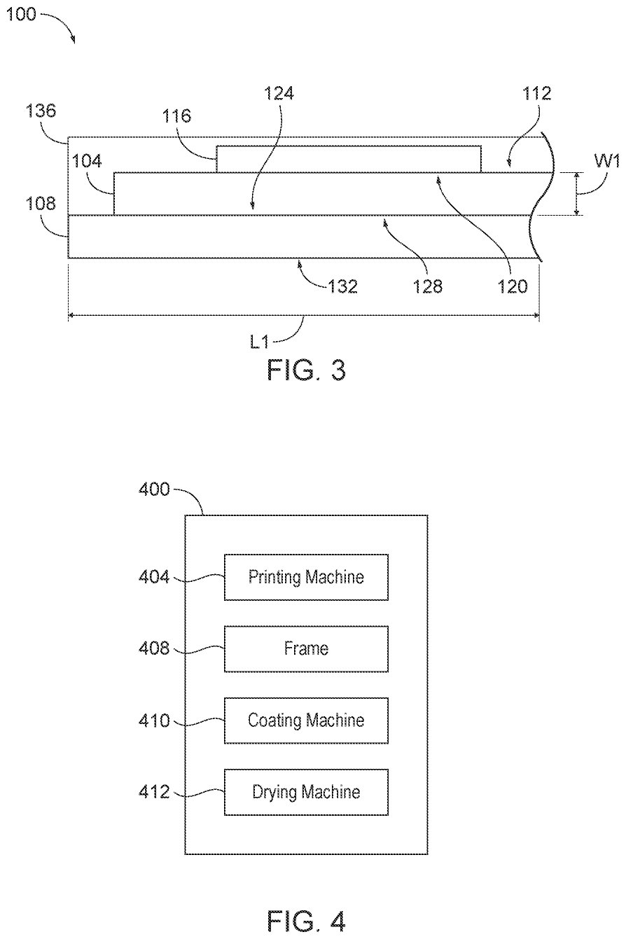

Referring to FIG. 4, the described methods may further incorporate a system 400 that includes a printing machine 404, a frame 408, a coating machine 410, and a drying machine 412.

The printing machine 404 is configured to print the image onto the paper substrate. An exemplary printing machine 404 is an inkjet printing machine, such as for example, Canon PRO 1000—Serial No. AEVW07871 or Canon PRO 4100—Serial No. BAPA 00777.

The frame 408 is configured to apply the printed substrate onto a barrier substrate and contain the varnish composition within the edges of the image applied to the paper substrate. The frame 408 is designed to provide a distinct edge around the printed image while also limiting bleed through of the image or the varnish. The frame 408 can be a structure that has selectively adjustable top, bottom and sides, such that different sized images can be used with the frame. In other words, the frame 408 is configured so that its length and width can be adjusted while keeping a smooth internal edge within the frame. The frame 408 may be comprised of multiple components, that, when coupled together form the frame structure.

In one embodiment, the frame 408 is a custom cut template system comprising custom cut aluminum or steel templates. Each custom cut template is cut utilizing a water or flow jet. The custom cut template exposes only the printed image. The non-printed border is partitioned off from the printed image. In another embodiment, the frame 408 is an adjustable template system.

The thickness of the template will be set to the desired height of the raised image. The template will create a 90 degree vertical wall between the printed image and the template. Thus, the 90 degree vertical wall will form a uniform, vertically-raised image. The template will function as a mold for vertically raising or elevating the inset image regardless of its shape, whether that be a squared or otherwise shaped text or image.

The templates will be held in position using a custom vacuum table (not depicted). When varnish mixture is introduced, the paper medium swells, appearing as waving. This waving occurs once wet; no matter how the varnish mixture is introduced. The waves may create opportunities for folding or buckling of the paper medium, especially while rolling the varnish mixture. This allows for the surface to be more difficult to evenly coat. A flat surface is therefore highly desirable to evenly coat the varnish mixture with a sufficient amount of material and minimize the chances for defects. The vacuum table holds both the printed substrate and template in position, thereby eliminating the swelling and waving, which occurs once the water soluble varnish mixture is introduced.

The coating machine 410 is configured to apply an even coat of varnish composition onto the printed substrate. In the illustrated embodiment, the coating machine 410 is a compressed air spray gun, such as, for example, an HVLP system configured for fine detail.

The drying machine 412 is configured to dry the printed substrate after the coating is applied. Any particular drying machine 412 may be used, such as hot air dryer, etc. In some cases, the drying machine 412 may be configured to adjust/control relative humidity and therefor moisture content to facilitate cure of the coating.

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the appended claims. The advantages and objects of the invention are not necessarily encompassed by each embodiment of the invention. Those skilled in the art will recognize or be able to ascertain using no more than routine experimentation, many equivalents to the specific embodiments of the invention described herein. Such equivalents are intended to be encompassed by the following claims.

All references disclosed herein are incorporated by reference in their entirety.

What is claimed:

1. A method for printing an image, comprising:
modifying an electronic image on a computing device to form a modified electronic image;
printing, with a printing machine, the modified electronic image on a paper substrate to form a printed substrate with an image thereon, wherein the paper substrate comprising a cellulosic material;
applying the printed substrate onto a barrier substrate
applying a template to the printed substrate and the barrier substrate to form a wall around an outer perimeter of the image;
coating the image with a curable varnish composition; and
drying the printed substrate in a humidity controlled environment to cure the varnish composition, thereby causing the image to extend upwardly from the base substrate a predetermined distance.

2. The method of claim 1, wherein modifying the image further includes adjusting colors and shaping of the electronic image.

3. The method of claim 1, wherein the printing step includes printing the image using archival pigment inks.

4. The method of claim 1, wherein applying the base substrate to the barrier substrate includes applying the base substrate to the barrier substrate with an adhesive.

5. The method of claim 1, wherein the applying step further includes positioning a template base on a lower side of the barrier substrate.

6. The method of claim 1, wherein the varnish composition comprises a mixture of a matte varnish, a satin varnish, and a gloss varnish.

7. The method of claim 1, wherein the varnish composition comprises a ratio of 2 parts satin varnish to 1 part matte varnish.

8. The method of claim 1, wherein the varnish composition comprises a ratio of 2 parts matte varnish to 1 part satin varnish.

9. The method of claim 1, wherein the coating step further includes:
a) spraying a first coat of varnish composition onto the image and drying the first coat;
b) spraying a second coat of varnish composition onto the image and drying the second coat;
c) spraying a third coat of varnish composition onto the printed substrate and drying the second coat; and
d) curing the coated varnish composition.

10. The method of claim 9, further comprising removing the template before the varnish composition is cured.

11. The method of claim 1, wherein the humidity controlled environment includes a) a temperature between 60 degrees and 65 degrees and b) a humidity less than about 75%.

12. The method of claim 1, further comprising applying pressure on the dried printed substrate for a predetermined period of time.

13. The method of claim 1, wherein the template is a frame that is a length and width adjustment to fit images of different sizes.

14. The method of claim 1, wherein the template includes a back side having a flat surface and a beveled edge that is non-perpendicular to the paper substrate.

15. An article comprising:
a base substrate having an upper surface, a lower surface opposite the upper surface, a length and a width;
a barrier substrate having a first side coupled to the lower surface base substrate and a second side opposite the first side; and
a coated image applied only to the upper surface of the base substrate and substantially within the length and width of the base substrate, the coating image having an image applied to the upper surface and a cured varnish composition that overlies the image, such that, the coated image extends upwardly from the upper surface of the base substrate a predetermined distance.

16. The article of claim 15, wherein the cured varnish composition comprises a set of pigment inks and a varnish composition.

17. The article of claim 16, wherein the set of pigments are archival pigment inks.

18. The article of claim 15, wherein the predetermined distance is at least 1.0 mm.

19. The article of claim 15, wherein the coated image does not create reverse indentation on the lower surface.

20. The article of claim 15, wherein an entirety of the coated images is spaced apart from the outer perimeter of the base substrate to define a border.

21. The article of claim 15, wherein an uppermost surface of the coated image is substantially plan along its entirety.

22. The article of claim 16, wherein the varnish composition comprises a mixture of matte varnish, a satin varnish, and a gloss varnish.

23. The article of claim 16, wherein the varnish composition comprises a ratio of 2 parts satin varnish to 1 part matte varnish.

24. The article of claim 16, wherein the varnish composition comprises a ratio of 2 parts matte varnish to 1 part satin varnish.
